(19) United States
(12) Patent Application Publication
(10) Pub. No.: US 2014/0334769 A1
(43) Pub. Date: Nov. 13, 2014

(54) OPTICAL CIRCUIT

(71) Applicant: Shigeru Nakamura, Tokyo (JP)

(72) Inventor: Shigeru Nakamura, Tokyo (JP)

(73) Assignee: NEC CORPORATION, Minato-ku, Tokyo (JP)

(21) Appl. No.: 14/117,326

(22) PCT Filed: May 10, 2012
(86) PCT No.: PCT/JP2012/062058

§ 371 Date: Nov. 12, 2013

(30) Foreign Application Priority Data
May 10, 2011 (JP) 2011-105004

(51) Int. Cl. G02F 1/313; G02B 6/125

(52) U.S. Cl. CPC G02F 1/3137; G02F 1/3131; G02B 6/125
USPC 385/14

(57) ABSTRACT

An optical circuit includes 1-in/4-out optical branching elements (3-1˜3-4), optical gate elements (4-1˜4-4) and 2-in/1-out optical selection elements (5-1˜5-4, 6-1˜6-4 and 7-1˜7-4). The optical branching elements (3-1˜3-4), the optical gate elements (4-1˜4-4) and the optical selection elements (5-1˜5-4, 6-1˜6-4 and 7-1˜7-4) are formed on the same substrate using optical waveguides. The optical selection elements (5-1˜5-4, 6-1˜6-4 and 7-1˜7-4) are arranged so that optical signals pass through a maximum of n levels (2ⁿ≧M) of the optical selection elements. The optical waveguides (8, 9) are arranged so that the number of times that one optical waveguide connected to input ports of an optical selection element intersects with the other optical waveguides is (N−1) times or less per level of the optical selection element.

### TECHNICAL FIELD

The present invention relates to an optical circuit used for an optical communication system or an optical interconnect system.

### BACKGROUND ART

In a fiber optic communication system, the use of wavelength division multiplexing (WDM: Wavelength Division Multiplexing) technology is becoming widespread, and increasing the flexibility of wavelength path setting is expected in future. In order for such wavelength path networks being realized, a function is considered mandate which, between a transmission line of an optical signal for which wavelength multiplexing is performed and an optical transmitter/receiver which transmits and receives the optical signal for each wavelength, set a route of the optical signal for each wavelength flexibly.

As a means for setting a route of an optical signal for each wavelength flexibly in connecting a plurality of transmission lines and a plurality of optical transmitter/receivers, for example, optical circuits disclosed in Japanese Patent Application Laid-Open No. 1993-30552, Japanese Patent Application Laid-Open No. 1986-194408, and Japanese Patent Application Laid-Open No. 1999-18119 are mentioned. A structure of such optical circuits is often called a split and select type optical circuit. A first example of the split and select type optical circuit is shown in FIG. 5. Concerning this optical circuit, although a mostly similar structure is used in a case when it is arranged between a transmission line and an optical receiver and in a case when it is arranged between the transmission line and an optical transmitter, hereinafter, explanation will be made by taking the case when it is arranged between the transmission line and the optical receiver as an example.

In a structure of FIG. 5, four ports 1-1˜1-4 on the transmission line side are connected with four ports 2-1˜2-4 on the optical receiver side using optical branching elements 51-1˜51-4, groups of optical gate elements 52-1˜52-4 and optical OR (OR) elements 53-1˜53-4. There is a case when, in place of the optical OR elements, optical junction elements disclosed in Japanese Patent Application Laid-Open No. 1999-18119 may be used. Each of the optical branching elements 51-1˜51-4 is 1-in/4-out. Optical signals inputted from the ports 1-1˜1-4 are made to branch to four by the optical branching elements 51-1˜51-4, and branched outputs of 4×4 are generated. These branched outputs of 4×4 are, after passing through the groups of optical gate elements 52-1˜52-4, inputted to the optical OR elements 53-1˜53-4. The groups of optical gate elements 52-1˜52-4 turn on or off each of the four branched outputs inputted from the optical branching elements 51-1˜51-4. The optical OR elements 53-1˜53-4 make the branched outputs which are turned on or off by the groups of optical gate elements 52-1˜52-4 join. In this way, connections of 1 to 1 or 1 vs. Q (Q≦4) are realized between the ports 1-1˜1-4 on the transmission line sides and the ports 2-1˜2-4 on the optical receiver side.

A second example of the split and select type optical circuit is shown in FIG. 6. Also in this case, explanation will be made by taking the case when the optical circuit is arranged between the transmission line and the optical receiver as an example. In a structure of FIG. 6, four ports 1-1˜1-4 on the transmission line side are connected with four ports 2-1˜2-4 on the optical receiver side using the optical branching elements 51-1˜51-4, the groups of optical gate elements 52-1˜52-4 and the optical OR elements 53-1˜53-4. Optical signals inputted from the ports 1-1˜1-4 are made to branch to four by the optical branching elements 51-1˜51-4. The groups of optical gate elements 52-1˜52-4 turn on or off each of the four branched outputs inputted from the optical branching elements 51-1˜51-4. The optical OR elements 53-1˜53-4 make the branched outputs which are turned on or off by the groups of optical gate elements 52-1˜52-4 join. In this way, also in the structure shown in FIG. 6, connections of 1 to 1 or 1 vs. Q (Q≦4) are realized between the ports 1-1˜1-4 on the transmission line side and the ports 2-1˜2-4 on the optical receiver side.

According to Japanese Patent Application Laid-Open No. 1993-30552, in case of FIG. 6, the optical branching element 51-1 and the group of optical gate elements 52-1, the optical branching element 51-2 and the group of optical gate elements 52-2, the optical branching element 51-3 and the group of optical gate elements 52-3, and the optical branching element 51-4 and the group of optical gate elements 52-4 are integrated on the same substrate respectively and the groups of optical gate elements 52-1˜52-4 are connected with the optical OR elements 53-1˜53-4 by an optical fiber. Also, according to Japanese Patent Application Laid-Open No. 1999-18119, a structure in which semiconductor optical amplifiers are used as the optical gate element and integrated on the same substrate together with the optical branching elements and the optical combining elements is disclosed.

### SUMMARY OF INVENTION

### Technical Problem

In case the optical circuits explained in FIG. 5 and FIG. 6 are structured by optical waveguides which are formed on the same substrate, necessity to intersect the optical waveguides arises. In case the optical waveguides intersect on the same substrate, loss or cross talk of an optical signal may be generated. The loss caused by the intersection of the optical waveguides when the optical signal propagates in one optical route is influenced by the total number of the intersections to pass through. Also, the cross talk caused by the intersection can be estimated by counting, among intersections to pass through, a part where other optical signals propagate in the intersecting waveguides.

In case the optical circuit of FIG. 5 is to be formed on the same substrate, intersections of optical routes will be generated between the optical branching elements 51-1˜51-4 and the groups of optical gate elements 52-1˜52-4, and the number of intersections in one optical route will be 9 at the maximum. When the loss is supposed to be L (dB) and the cross talk to be X (dB) per one intersection, the loss of 9L (dB) and the cross talk of 9.5+X (dB) can be considered to be generated at the maximum caused by the intersection. Here, by supposing that optical signals with the same strength propagate in sixteen optical routes between the optical branching elements 51-1˜51-4 and the groups of optical gate elements 52-1˜52-4, and the cross talk per one intersection is added simply; the cross talk per one optical route is calculated.

Also, in case the optical circuit of FIG. 6 is to be structured by the optical waveguides formed on the same substrate, intersections of optical routes will be generated between the groups of optical gate elements 52-1˜52-4 and the optical OR elements 53-1˜53-4, and the number of the intersections in one optical route will also be 9 at the maximum. The loss caused by the intersection will be 9L (dB) at the maximum. Since among sixteen optical routes between the groups of optical gate elements 52-1˜52-4 and the optical OR elements 53-1˜53-4, those in which optical signals propagate are four and the optical signals in the optical routes other than that are blocked by the optical gate elements, the cross talk caused by the intersection will be 5+X (dB) at the maximum.

Further, in Japanese Patent Application Laid-Open No. 1993-30552, since it is not assumed that the optical branching elements, the optical gate elements and the optical selection elements are structured by the optical waveguides formed on the same substrate, there are no descriptions or suggestions about an arrangement of intersection. Also, in Japanese Patent Application Laid-Open No. 1999-18119, although it is disclosed that an optical crossbar switch including the optical branching elements, the optical gate elements and the optical junction elements is formed on a semiconductor substrate, there are no descriptions or suggestions about an arrangement of intersection. In FIG. 4 of Japanese Patent Application Laid-Open No. 1999-18119, a structure in which intersection is arranged between the optical gate elements and the optical junction elements is disclose and, in this case, though among sixteen optical routes between the optical gate elements and the optical junction elements, those in which optical signals propagate are four, since the optical signals from the four optical routes which join are added to the optical junction elements with the same light intensity, the cross talk caused by the intersection will be 9.5+X (dB).

The object of the present invention is, in split and select type optical circuits which form optical branching elements, optical gate elements and optical selection elements on the same substrate and sets optical routes flexibly between a plurality of input ports and a plurality of output ports, to provide an optical circuit structure which suppresses loss and cross talk of optical signals caused by intersection of optical waveguides to the minimum.

### Solution to Problem

An optical circuit of the present invention is characterized by including: a substrate; a plurality of optical branching elements connected to a plurality of first external connection ports; a plurality of optical gate elements connected to the plurality of optical branching elements; a plurality of optical selection elements for connecting between outputs of the plurality of optical gate elements and a plurality of second external connection ports; and optical waveguides for connecting between the elements; wherein the plurality of optical branching elements, the plurality of optical gate elements and the plurality of optical selection elements are formed on the substrate using the optical waveguides; and among the optical waveguides which connect between the elements, the optical waveguides which are arranged between the plurality of optical gate elements and the plurality of second external connection ports intersect.

### Advantageous Effects of Invention

According to the present invention, by arranging 2-in/1-out optical selection elements by a structure of 1 level or a plurality of levels of cascade connection, and by arranging intersection of optical waveguides distributedly for each level, loss of optical signals caused by the intersection of the optical waveguides can be suppressed. As a result, in the present invention, in split and select type optical circuits which integrated the optical branching elements, the optical gate elements and the optical selection elements on the same substrate, loss and cross talk caused by the intersection of the optical waveguides can be suppressed to the minimum.

### BRIEF DESCRIPTION OF DRAWINGS

FIG. 1 is a block diagram of an optical circuit according to the first example of the present invention.

FIG. 2 is a perspective view showing a structure of an optical gate element in the first example of the present invention.

FIG. 3 is a perspective view showing a structure of an optical selection element in the first example of the present invention.

FIG. 4 is a block diagram of an optical circuit according to the second example of the present invention.

FIG. 5 is a block diagram of a split and select type optical circuit related to the present invention.

FIG. 6 is another block diagram of a split and select type optical circuit related to the present invention.

### DESCRIPTION OF EMBODIMENTS

### The First Example

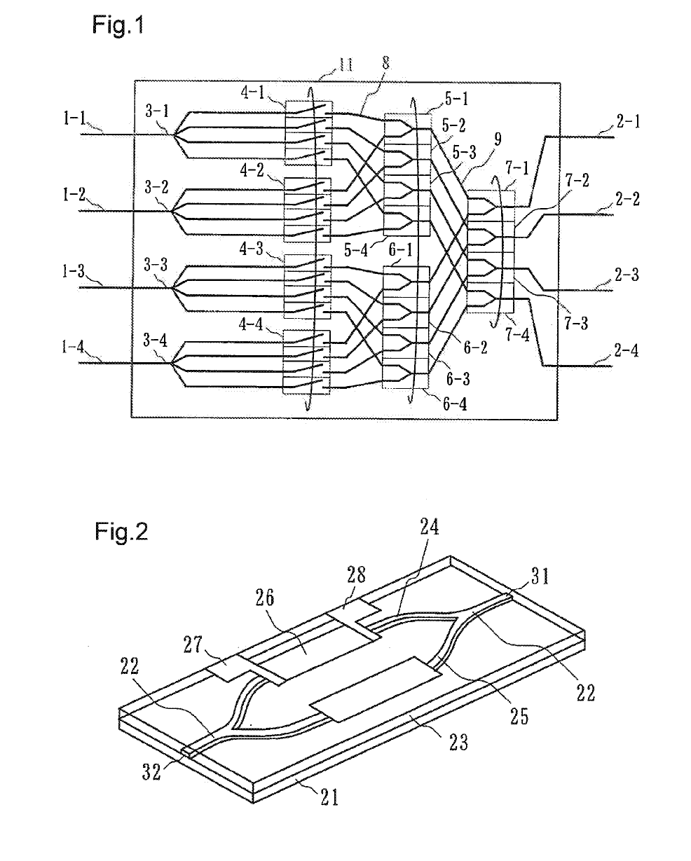

Next, an example of the present invention will be described with reference to FIG. 1. FIG. 1 is a block diagram of an optical circuit according to the first example of the present invention. In explanation of FIG. 1 too, the explanation will be made by taking a case when it is used as the optical circuit which connects between a plurality of transmission lines and a plurality of optical receivers as an example. Input ports 1-1˜1-4 which are external connection port of M (M is an integer and is no smaller than 2, and in this example, M=4) on the transmission line side are connected with output ports 2-1˜2-4 which are external connection ports of N (N is an integer and is no smaller than 2, and in this example, N=4) on the optical receiver side via optical branching elements 3-1˜3-4, optical gate elements 4-1˜4-4 and optical selection elements 5-1˜5-4, 6-1˜6-4 and 7-1˜7-4. The optical branching elements 3-1˜3-4, the optical gate elements 4-1˜4-4, the optical selection elements 5-1˜5-4, 6-1˜6-4 and 7-1˜7-4 are formed using optical waveguides on a same optical circuit substrate 11.

The optical branching elements 3-1˜3-4 are formed for each of the input ports 1-1˜1-4. Each of the optical branching elements 3-1˜3-4 is 1-in/N-out. Optical signals inputted from the input ports 1-1˜1-4 of M are made to branch to N outputs by the optical branching elements 3-1˜3-4 and branched outputs of M×N pieces are generated. The optical gate elements 4-1˜4-4 are formed for each of the input ports 1-1˜1-4, and N pieces are formed per one input port. As a result, the optical gate elements 4-1˜4-4 of M×N pieces are connected to each output of the optical branching elements 3-1˜3-4 one each. Each of the optical gate elements 4-1˜4-4 turns on or off optical signals outputted from the optical branching elements 3-1˜3-4 respectively. Among the optical gate elements 4-1˜4-4 of M×N pieces, those which become in on state are N pieces, and all the rest will be in off state.

Each of the optical selection elements 5-1˜5-4, 6-1˜6-4 and 7-1˜7-4 is 2-in/1-out. The optical selection elements 5-1˜5-4 and 6-1˜6-4 are formed at a rate of N pieces per two input ports. The optical selection elements 7-1˜7-4 are formed for each of the output ports 2-1˜2-4. Each of the optical selection elements 5-1˜5-4, 6-1˜6-4 and 7-1˜7-4 selects and outputs either one of two inputs. The optical selection elements 5-i (i is an integer and is 1−N) selects and outputs either one of the optical signal which is outputted from i-th optical gate element among the optical gate elements 4-1 of N pieces or the optical signal which is outputted from i-th optical gate element among the optical gate elements 4-2 of N pieces. The optical selection element 6-i selects and outputs either one of the optical signal which is outputted from i-th optical gate element among the optical gate elements 4-3 of N pieces or the optical signal which is outputted from i-th optical gate element among the optical gate elements 4-4 of N pieces. The optical selection element 7-i selects and outputs either one of the optical signal which is outputted from the optical selection element 5-i or the optical signal which is outputted from the optical selection element 6-i.

In this way, in this example, connections of 1 to 1 or 1 vs. P (P≦N) can be realized between the input ports 1-1˜1-4 on the transmission line side and the output ports 2-1˜2-4 on the optical receiver side.

FIG. 2 is a perspective view showing a structure of the optical gate elements 4-1˜4-4. Here, a core covered by a clad is seen through and described. Each of the optical gate elements 4-1˜4-4 of M×N pieces is an element of Mach-Zehnder type equipped with an input port 31 and an output port 32. Each of the optical gate elements 4-1˜4-4 of M×N pieces is formed using an optical waveguide including: a silicon substrate 21; a lower part clad made from quartz which is formed on the silicon substrate 21 and not illustrated; a core 22 made from silicon and formed on the lower part clad; and an upper part clad 23 made from quartz and which covers the core 22 respectively. The core 22 connected to the input port 31 is structured so that it branches into two on the way, and they join in one again and an optical signal is outputted from the output port 32 after that. Among branching parts 24 and 25 of the core 22, a heater 26 is formed on one branching part 24.

Although interference is generated when the optical signal inputted from the input port 31 joins in one core 22 again via the branching parts 24 and 25, in case no current is applied to the heater 26, phase difference of the joined optical signals will be π and they will be in a state of weakening each other. For this reason, the optical gate element will be in a state to block the optical signal. On the other hand, when predetermined current is applied to the heater 26 via electrode pads 27 and 28, when the optical signal inputted from the input port 31 joins via the branching parts 24 and 25, phase difference of the joined optical signals will be 0 and they will be in a state of strengthening each other. For this reason, the optical gate element will be in a state to pass through the optical signal. By forming the optical waveguide so that characteristics of the phase differences as above may be satisfied, it is possible to turn on or off the optical signal inputted from the input port 31.

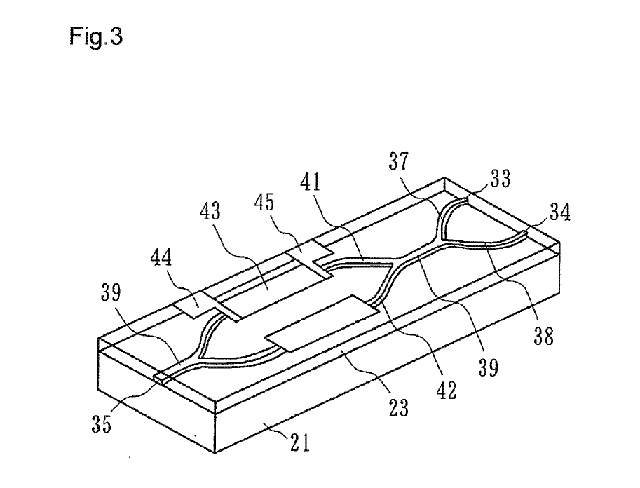

FIG. 3 is a perspective view showing a structure of the optical selection elements 5-1˜5-4, 6-1˜6-4 and 7-1˜7-4. Here, a core covered by a clad is seen through and described. Each of the optical selection elements 5-1˜5-4, 6-1˜6-4 and 7-1˜7-4 is an element of Mach-Zehnder type equipped with input ports 33 and 34 and an output port 35. Each of the optical selection elements 5-1˜5-4, 6-1˜6-4 and 7-1˜7-4 is formed using an optical waveguide including: the silicon substrate 21; the lower part clad made from quartz which formed on the silicon substrate 21 and not illustrated; cores 37˜39 made from silicon and formed on the lower part clad; and the upper part clad 23 made from quartz and which covers the cores 37˜39 respectively. The core 37 connected to the input port 33 and the core 38 connected to the input port 34 join with one core 39 on the way. Further, the core 39 is structured so that it branches into two on the way, and they join in one again and an optical signal is outputted from the output port 35 after that. Among branching parts 41 and 42 of the core 39, a heater 43 is formed on one branching part 41.

In case no current is applied to the heater 43, when the optical signal inputted from the input port 33 joins in one core 39 again via the branching parts 41 and 42, phase difference of the joined optical signals will be 0 and they will be in a state of strengthening each other. On the other hand, for the optical signal inputted from the input port 34, phase difference of the optical signals joined via the branching parts 41 and 42 will be π and they will be in a state of weakening each other. For this reason, the optical selection element will be in a state to pass through the optical signal from the input port 33 to the output port 35.

In contrast, when predetermined current is applied to the heater 43 via electrode pads 44 and 45, when the optical signal inputted from the input port 34 joins in one core 39 again via the branching parts 41 and 42, phase difference of the joined optical signals will be 0 and they will be in a state of strengthening each other. On the other hand, for the optical signal inputted from the input port 33, phase difference of the optical signals joined via the branching parts 41 and 42 will be π and they will be in a state of weakening each other. For this reason, the optical selection element will be in a state to pass through the optical signal from the input port 34 to the output port 35. By forming the optical waveguide so that characteristics of the phase differences as above may be satisfied, it is possible to select and output either one among the optical signals inputted from two input ports 33 and 34.

In the optical circuit shown in FIG. 1, the optical gate elements 4-1˜4-4 are connected with the optical selection elements 5-1˜5-4 and 6-1˜6-4 using an optical waveguide 8, and the optical selection elements 5-1˜5-4 and 6-1˜6-4 are connected with the optical selection elements 7-1˜7-4 using an optical waveguide 9. The optical waveguides 8 and 9 are also structured from: the silicon substrate; the lower part clad made from quartz and formed on the silicon substrate; the core made from silicon and formed on the lower part clad; and the upper part clad made from quartz and which covers the core. In this example, by making a plurality of optical waveguides 8 intersect on the silicon substrate, the optical gate elements 4-1˜4-4 are connected with the optical selection elements 5-1˜5-4 and 6-1˜6-4, and also by making a plurality of optical waveguides 9 intersect on the silicon substrate, the optical selection elements 5-1˜5-4 and 6-1˜6-4 are connected with the optical selection elements 7-1˜7-4.

In the present invention, the optical selection elements are arranged by a structure of 1 level or a plurality of levels of cascade connection so that the optical signal may pass through the optical selection elements of maximum of n levels (n is an integer and is no smaller than 1 and 2ⁿ≧M). In this example, the optical selection element is made a two-level structure. And in this example, the optical waveguides 8 and 9 used for connecting between the optical gate elements 4-1˜4-4 and the optical selection elements 5-1˜5-4 and 6-1˜6-4 and for connecting between the optical selection elements 5-1˜5-4 and 6-1˜6-4 and the optical selection elements 7-1˜7-4 are arranged so that the number of times one optical waveguide connected to the input ports of the optical selection elements 5-1˜5-4, 6-1˜6-4 and 7-1˜7-4 intersects with the other optical waveguides is (N−1) times or less per level of the optical selection element.

In this example, since the optical selection element is made the two-level structure, the maximum number of intersection times of the optical waveguide in one optical route from the input ports 1-1˜1-4 to the output ports 2-1˜2-4 of the optical circuit will be 2×(N−1)=6 times. When the loss per one intersection is supposed to be L (dB), then the loss caused by the intersection will be 6L (dB) at the maximum.

Also, among the optical routes after the optical gate elements 4-1˜4-4, those in which optical signals propagate are N=4, and the optical signals in the optical routes other than that are blocked by the optical gate elements 4-1˜4-4. Accordingly, when the cross talk per one intersection is supposed to be X (dB), then the cross talk caused by the intersection will be 5+X (dB) at the maximum. In this way, in this example, loss and cross talk of optical signals caused by intersection of optical waveguides can be suppressed to the minimum.

### The Second Example

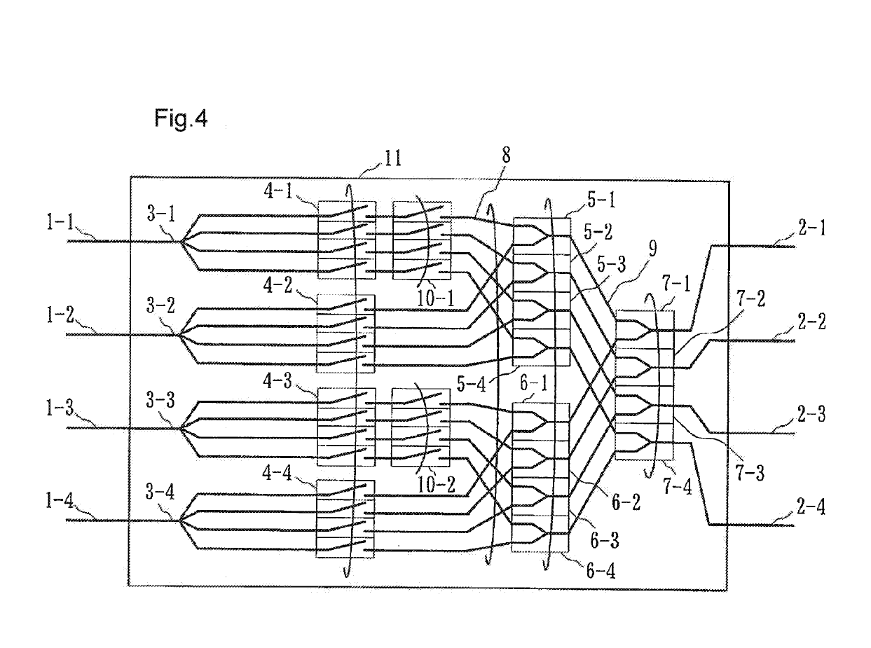

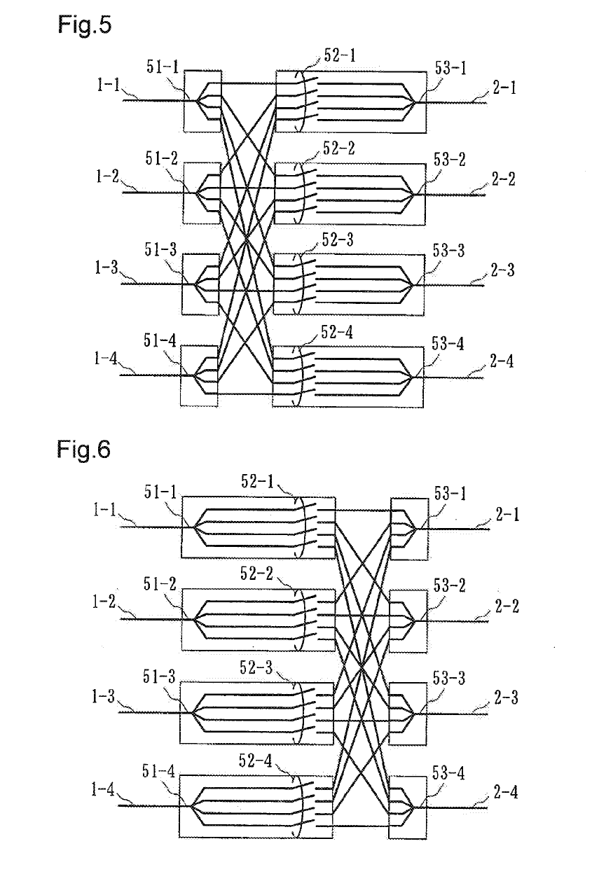

Next, another example of the present invention will be described with reference to FIG. 4. FIG. 4 is a block diagram of an optical circuit according to the second example of the present invention. In explanation of FIG. 4 too, the explanation will be made by taking a case when it is used as the optical circuit which connects between a plurality of transmission lines and a plurality of optical receivers as an example. Input ports 1-1˜1-4 of M (M is an integer and is no smaller than 2, and in this example, M=4) on the transmission line side are connected with output ports 2-1˜2-4 of N (N is an integer and is no smaller than 2, and in this example, N=4) on the optical receiver side via optical branching elements 3-1˜3-4, optical gate elements 4-1˜4-4, 10-1 and 10-2, and optical selection elements 5-1˜5-4, 6-1˜6-4 and 7-1˜7-4. The optical branching elements 3-1˜3-4, the optical gate elements 4-1˜4-4, 10-1 and 10-2 and the optical selection elements 5-1˜5-4, 6-1˜6-4 and 7-1˜7-4 are formed using optical waveguides on a same optical circuit substrate 11. Further, in this example, M×N is an even number.

The optical branching elements 3-1˜3-4 are formed for each of the input ports 1-1˜1-4. Each of the optical branching elements 3-1˜3-4 is 1-in/N-out. Optical signals inputted from the input ports 1-1˜1-4 of M are made to branch to N outputs by the optical branching elements 3-1˜3-4 and branched output of M×N pieces are generated. The optical gate elements 4-1˜4-4 are formed for each of the input ports 1-1˜1-4, and N pieces are formed per one input port. As a result, the optical gate elements 4-1˜4-4 of M×N pieces are connected to each output of the optical branching elements 3-1˜3-4 one each. Each of the optical gate elements 4-1˜4-4 turns on or off optical signals outputted from the optical branching elements 3-1˜3-4 respectively. Among the optical gate elements 4-1˜4-4 of M×N pieces, those which become in on state are N pieces, and all the rests will be in off state.

The optical gate elements 10-1 and 10-2 are formed for half of the optical gate elements 4-1˜4-4 of M×N pieces. The optical gate element 10-1 is connected to each output of the optical gate element 4-1 one each, and the optical gate element 10-2 is connected to each output of the optical gate element 4-3 one each. Also, each of the optical selection elements 5-1˜5-4, 6-1˜6-4 and 7-1˜7-4 is 2-in/1-out. The optical selection elements 5-1˜5-4 and 6-1˜6-4 are formed at a rate of N pieces per two input ports. Among two inputs of each of the optical selection elements, one passes through both of either one of the optical gate elements 4-1˜4-4 and either one of the optical gate elements 10-1˜10-2, and the other passes through either one of the optical gate elements 4-1˜4-4. Further, the optical selection elements 7-1˜7-4 are formed for each of the output ports 2-1˜2-4. Each of the optical selection elements 5-1˜5-4, 6-1˜6-4 and 7-1˜7-4 selects and outputs either one of two inputs. The optical selection element 5-i (i is an integer and is 1−N) selects and outputs either one of the optical signal which is outputted from i-th optical gate element among the optical gate elements 10-1 of N pieces or the optical signal which is outputted from i-th optical gate element among the optical gate elements 4-2 of N pieces. The optical selection element 6-i selects and outputs either one of the optical signal which is outputted from i-th optical gate element among the optical gate elements 10-2 of N pieces or the optical signal which is outputted from i-th optical gate element among the optical gate elements 4-4 of N pieces. The optical selection element 7-i selects and outputs either one of the optical signal which is outputted from the optical selection element 5-i or the optical signal which is outputted from the optical selection element 6-i.

In this way, in this example, connections of 1 to 1 or 1 vs. P (P≦N) can be realized between the input ports 1-1˜1-4 on the transmission line side and the output ports 2-1˜2-4 on the optical receiver side.

As for a structure of the optical gate elements 4-1˜4-4, 10-1 and 10-2, a perspective view is shown in FIG. 2 same as the first example. Also, as for a structure of the optical selection elements 5-1˜5-4, 6-1˜6-4 and 7-1˜7-4, a perspective view is shown in FIG. 3 same as the first example.

In the optical circuit of FIG. 4, when an optical signal is to be propagated from the input port 1-1 on the transmission line side to either output port of 2-1˜2-4 on the optical receiver side, current is applied to heaters of the optical gate element 4-1 and the optical gate element 10-1. In other word, in case the optical signal is not to be propagated from the input port 1-1 on the transmission line side to either output port of 2-1˜2-4 on the optical receiver side, the optical signal is blocked by making it pass through the optical gate element 4-1 for which current is not applied to the heater and which is in off state and the optical gate element 10-1 for which current is not applied to the heater and which is in off state. Also, when an optical signal is to be propagated from the input port 1-2 on the transmission line side to either output port of 2-1˜2-4 on the optical receiver side, current is applied to heaters of the optical gate element 4-2 and either of the optical selection elements 5-1˜5-4. In other words, in case the optical signal is not to be propagated from the input port 1-2 on the transmission line side to either output port of 2-1˜2-4 on the optical receiver side, the optical signal is blocked by making it pass through the optical gate element 4-2 for which current is not applied to the heater and which is in off state and either of the optical selection elements 5-1˜5-4 for which current is not applied to the heater and which is in off state.

Optical signal route setting from the input port 1-3 on the transmission line side to either output port of 2-1˜2-4 on the optical receiver side, and optical signal route setting from the input port 1-4 on the transmission line side to either output port of 2-1˜2-4 on the optical receiver side are also similar. That is, when an optical signal is to be propagated from the input port 1-3 on the transmission line side to either output port of 2-1˜2-4 on the optical receiver side, current is applied to heaters of the optical gate element 4-3 and the optical gate element 10-2. In other words, in case the optical signal is not to be propagated from the input port 1-3 on the transmission line side to either output port of 2-1˜2-4 on the optical receiver side, the optical signal is blocked by making it pass through the optical gate element 4-3 for which current is not applied to the heater and which is in off state and the optical gate element 10-2 for which current is not applied to the heater and which is in off state. Also, when an optical signal is to be propagated from the input port 1-4 on the transmission line side to either output port of 2-1˜2-4 on the optical receiver side, current is applied to heaters of the optical gate element 4-4 and either of the optical selection element 6-1˜6-4. In other words, in case the optical signal is not to be propagated from the input port 1-4 on the transmission line side to either output port of 2-1˜2-4 on the optical receiver side, the optical signal is blocked by making it pass through the optical gate element 4-4 for which current is not applied to the heater and which is in off state and either of the optical selection elements 6-1˜6-4 for which current is not applied to the heater and which is in off state.

In this way and in this example, blocking of the optical signal between the input ports 1-1˜1-4 on the transmission line side and the output ports 2-1˜2-4 on the optical receiver side is carried out by passing it through at least two of the optical gate elements or the optical selection elements for which current is not applied to the heaters and which are in off state, and is made so that blocking of the optical signal is not influenced by fluctuation of heater current.

In the optical circuit shown in FIG. 4, the optical gate elements 10-1, 4-2, 10-2 and 4-4 are connected with the optical selection element 5-1˜5-4 and 6-1˜6-4 using an optical waveguide 8, and the optical selection elements 5-1˜5-4 and 6-1˜6-4 are connected with the optical selection elements 7-1˜7-4 using an optical waveguide 9. The optical waveguides 8 and 9 are also structured from: the silicon substrate; the lower part clad made from quartz and formed on the silicon substrate; the core made from silicon and formed on the lower part clad; and the upper part clad made from quartz and which covers the core. In this example, by making a plurality of optical waveguides 8 intersect on the silicon substrate, the optical gate elements 10-1, 4-2, 10-2 and 4-4 are connected with the optical selection elements 5-1˜5-4 and 6-1˜6-4, and also by making a plurality of optical waveguides 9 intersect on the silicon substrate, the optical selection elements 5-1˜5-4 and 6-1˜6-4 are connected with the optical selection elements 7-1˜7-4.

In the present invention, the optical selection elements are arranged by a structure of 1 level or a plurality of levels of cascade connection so that the optical signal may pass through the optical selection elements of maximum of n levels (n is an integer and is no smaller than 1 and 2ⁿ≧M). In this example, the optical selection element is made a two-level structure. And in this example, the optical waveguides 8 and 9 used for connecting between the optical gate elements 10-1, 4-2, 10-2 and 4-4 and the optical selection elements 5-1˜5-4 and 6-1˜6-4 and for connecting between the optical selection elements 5-1˜5-4 and 6-1˜6-4 and the optical selection elements 7-1˜7-4 are arranged so that the number of times one optical waveguide connected to the input ports of the optical selection elements 5-1˜5-4, 6-1˜6-4 and 7-1˜7-4 intersects with the other optical waveguides is (N−1) times or less per level of the optical selection element.

In this example, since the optical selection element is made the two-level structure, the maximum number of intersection times of the optical waveguide in one optical route from the input ports 1-1˜1-4 to the output ports 2-1˜2-4 of the optical circuit will be 2×(N−1)=6 times. When the loss per one intersection is supposed to be L (dB), then the loss caused by the intersection will be 6L (dB) at the maximum.

Also, among the optical routes after the optical gate elements 4-1˜4-4, those in which optical signals propagate are N=4, and optical signals in the optical routes other than that are blocked by the optical gate elements 4-1˜4-4. Accordingly, when the cross talk per one intersection is supposed to be X (dB), then, the cross talk caused by the intersection will be 5+X (dB) at the maximum. In this way, in this example, loss and cross talk of optical signals caused by intersection of optical waveguides can be suppressed to the minimum.

As above, in the first example and the second example, the optical circuit is explained for a case where silicon is made a waveguide core and quartz glass is made a clad, however, other than that, a case where the core and the clad are formed from quartz glass, a case where the core and the clad are formed from compound semiconductor, a case where the core and the clad are formed from organic material and so on can be considered. In the first example and the second example, regardless of the constituent materials of the optical waveguides, effects mentioned above can be obtained. Also, in the first example and the second example, although optical gate elements and optical selection elements which perform optical path switching by applying heat using a heater have been explained, they are not limited to this and optical gate elements and optical selection elements which perform optical path switching by applying voltage or carrier injection may be used.

Although part or all of the examples mentioned above may also be described as the following supplementary notes, they are not limited to the following.

(Supplementary note 1) An optical circuit characterized by including: a substrate; a plurality of optical branching elements connected to a plurality of first external connection ports; a plurality of optical gate elements connected to the plurality of optical branching elements; a plurality of optical selection elements for connecting between outputs of the plurality of optical gate elements and a plurality of second external connection ports; and optical waveguides for connecting between the elements, wherein the plurality of optical branching elements, the plurality of optical gate elements and the plurality of optical selection elements are formed on the substrate using the optical waveguides; and among the optical waveguides which connect between the elements, the optical waveguides which are arranged between the plurality of optical gate elements and the plurality of second external connection ports intersect.

(Supplementary note 2) The optical circuit described in supplementary note 1 and the optical circuit characterized by the plurality of optical branching elements being formed for each of the first external connection ports of M (M is an integer and is no smaller than 2) and being 1-in/N-out elements which make an optical signal inputted from the first external connection port branch to N (N is an integer and is no smaller than 2) outputs; the plurality of optical gate elements being elements of M×N pieces which turn on or off each output of the plurality of optical branching elements; the plurality of optical selection elements being a plurality of 2-in/1-out elements for connecting between outputs of the plurality of optical gate elements and the second external connection ports of N and being arranged by a structure of 1 level or a structure of a plurality of levels of cascade connection so that the optical signals pass through the optical selection elements of maximum of n levels (n is an integer and is no smaller than 1 and 2ⁿ≧M); and among the optical waveguides which connect between the elements, the optical waveguides which are used for connecting between the optical gate elements and the optical selection elements and between the optical selection elements being arranged so that the number of times which one optical waveguide connected to input ports of the optical selection elements intersects with the other optical waveguides is (N−1) times or less per level of the optical selection element.

(Supplementary note 3) The optical circuit described in supplementary note 1 and the optical circuit characterized by the plurality of optical branching elements being formed for each of the first external connection ports of M (M is an integer and is no smaller than 2) and being 1-in/N-out elements which make an optical signal inputted from the first external connection port branch to N (N is an integer and is no smaller than 2) outputs; the plurality of optical gate elements including first optical gate elements of M×N pieces (M×N is an even number) which turn on or off each output of the plurality of optical branching elements and second optical gate elements of M×N/2 which turn on or off each output of half of the first optical gate elements; the plurality of optical selection elements being a plurality of 2-in/1-out elements for connecting between outputs of the first optical gate element or the second optical gate elements and the second external connection ports of N and being arranged by a structure of 1 level or a structure of a plurality of levels of cascade connection so that the optical signals pass through the optical selection elements of maximum of n levels (n is an integer and is no smaller than 1 and 2ⁿ≧M); among the plurality of optical selection elements, for 2-in/1-out optical selection elements to which the outputs of the first optical gate element or the second optical gate element are connected, one input being connected to the output of the first optical gate elements and the other input being connected to the output of the second optical gate elements; and among the optical waveguides which connect between the elements, the optical waveguides which are used for connecting between the optical gate elements and the optical selection elements and between the optical selection elements being arranged so that the number of times which one optical waveguide connected to input ports of the optical selection elements intersects with the other optical waveguides is (N−1) times or less per level of the optical selection element.

(Supplementary note 4) The optical circuit described in supplementary note 1 and the optical circuit characterized by the optical gate elements and the optical selection elements being a Mach-Zehnder type element.

(Supplementary note 5) The optical circuit described in supplementary note 1 and the optical circuit characterized by the optical waveguides including at least one among: silicon, quartz glass, compound semiconductor and organic material.

As above, the present invention has been explained with reference to the examples mentioned above, though the present invention is not limited only to the examples mentioned above. As for the composition or details of the present invention, the examples mentioned above may be combined appropriately and used, and further, they can be changed appropriately within the scope of the claims of the present invention.

This application claims priority based on Japanese Patent Application No. 2011-105004 filed on May 10, 2011 and the disclosure thereof is incorporated herein in its entirety.

### INDUSTRIAL APPLICABILITY

The present invention can be applied to an optical circuit of split and select type.

### REFERENCE SIGNS LIST

1-1˜1-4 Input port; 2-1˜2-4 Output port; 3-1˜3-4 Optical branching element; 4-1˜4-4, 10-1, 10-2 Optical gate element; 5-1˜5-4, 6-1˜6-4, 7-1˜7-4 Optical selection element; 8, 9 Optical waveguide; 11 Optical circuit substrate; 21 Silicon substrate; 22, 37˜39 Core; 23 Upper clad; 24, 25, 41, 42 Branching part; 26, 43 Heater; 27, 28, 44, 45 Electrode pad; 31, 33, 34 Input port; 32, 35 Output port

1. An optical circuit characterized by comprising: a substrate;
a plurality of optical branching elements connected to a plurality of first external connection ports;
a plurality of optical gate elements connected to said plurality of optical branching elements;
a plurality of optical selection elements for connecting between outputs of said plurality of optical gate elements and a plurality of second external connection ports; and
optical waveguides for connecting between the elements, wherein
said plurality of optical branching elements, said plurality of optical gate elements and said plurality of optical selection elements are formed on said substrate using the optical waveguides; and
among the optical waveguides which connect between said elements, the optical waveguides which are arranged between said plurality of optical gate elements and said plurality of second external connection ports intersect.

2. The optical circuit according to claim 1 and the optical circuit characterized by
said plurality of optical branching elements being formed for each of the first external connection ports of M (M is an integer and is no smaller than 2) and being 1-in/N-out elements which make an optical signal inputted from the first external connection port branch to N (N is an integer and is no smaller than 2) outputs;
said plurality of optical gate elements being elements of M×N pieces which turn on or off each output of said plurality of optical branching elements;
said plurality of optical selection elements being a plurality of 2-in/1-out elements for connecting between outputs of said plurality of optical gate elements and the second external connection ports of N and being arranged by a structure of 1 level or a structure of a plurality of levels of cascade connection so that the optical signals pass through the optical selection elements of maximum of n levels (n is an integer and is no smaller than 1 and 2ⁿ≧M); and
among the optical waveguides which connect between said elements, the optical waveguides which are used for connecting between said optical gate elements and said optical selection elements and between the optical selection elements being arranged so that the number of times which one optical waveguide connected to input ports of said optical selection elements intersects with the other optical waveguides is (N−1) times or less per level of the optical selection element.

3. The optical circuit according to claim 1 and the optical circuit characterized by
said plurality of optical branching elements being formed for each of the first external connection ports of M (M is an integer and is no smaller than 2) and being 1-in/N-out elements which make an optical signal inputted from the first external connection port branch to N (N is an integer and is no smaller than 2) outputs;
said plurality of optical gate elements including first optical gate elements of M×N pieces (M×N is an even number) which turn on or off each output of said plurality of optical branching elements and second optical gate elements of M×N/2 which turn on or off each output of half of the first optical gate elements;
said plurality of optical selection elements being a plurality of 2-in/1-out elements for connecting between outputs of said first optical gate elements or the second optical gate elements and the second external connection ports of N and being arranged by a structure of 1 level or a structure of a plurality of levels of cascade connection so that the optical signals pass through the optical selection elements of maximum of n levels (n is an integer and is no smaller than 1 and 2ⁿ≧M);
among said plurality of optical selection elements, for 2-in/1-out optical selection elements to which the outputs of said first optical gate elements or the second optical gate elements are connected, one input being connected to the output of said first optical gate elements and the other input being connected to the output of said second optical gate elements; and
among the optical waveguides which connect between said elements, the optical waveguides which are used for connecting between said optical gate elements and said optical selection elements and between the optical selection elements being arranged so that the number of times which one optical waveguide connected to input ports of said optical selection elements intersects with the other optical waveguides is (N−1) times or less per level of the optical selection element.

4. The optical circuit according to claim 1 and the optical circuit characterized by
said optical gate elements and said optical selection elements being a Mach-Zehnder type element.

5. The optical circuit according to claim 1 and the optical circuit characterized by
said optical waveguides comprising at least one among: silicon, quartz glass, compound semiconductor and organic material.
